(19) United States
(12) Patent Application Publication
(10) Pub. No.: US 2009/0230175 A1
(43) Pub. Date: Sep. 17, 2009

(54) Flux for soldering and method for manufacturing an electronic device using the same

(75) Inventor: Fumiyoshi Kawashiro, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/382,054

(22) Filed: Mar. 6, 2009

(30) Foreign Application Priority Data
Mar. 11, 2008 (JP) 60506/2008

(51) Int. Cl. B23K 1/20; B23K 35/34

(52) U.S. Cl. 228/223; 148/23

(57) ABSTRACT

A flux for soldering of the present invention, in connecting a mounting pad exposed on a board to a solder ball, is applied onto at least one of a surface of the mounting pad and the solder ball. The flux for soldering contains a solvent, and the solvent contains a compound, which is represented by a general formula (1) and having a boiling point of 218° C. or higher and 240° C. or lower: R¹-R²n-OH . . . (1).

### BACKGROUND OF THE INVENTION

1. Field of the Invention

The present invention relates to a flux for soldering and a method for manufacturing an electronic device using the same.

2. Description of the Related Art

Japanese Patent Application Laid-open No. Hei 6-71476 describes a flux for soldering containing a solvent having a boiling point of 270 to 330° C., such as triethylene glycol and tetraethylene glycol.

Japanese Patent Application Laid-open No. 2001-232496 describes a flux for soldering containing a polyhydric alcohol having a boiling point of 245° C. or higher or a derivative thereof as a solvent. Examples of such a solvent include butyl carbitol acetate, dibutyl carbitol, hexyl carbitol, and ethylene glycol monophenyl ether acetate.

Japanese Patent Application Laid-open No. 2002-336993 describes a solder paste composition containing an organic solvent having a boiling point of higher than 230° C. Examples of such an organic solvent include butyl carbitol, diethylene glycol, dipropylene glycol, triethylene glycol, hexyl diglycol, and ethyl hexyl diglycol.

However, related arts described in the above-mentioned documents have room for improvement in terms of the following points.

The problems to be solved by the present invention are described with reference to the accompanying drawings. FIGS. 4A to 5B are cross-sectional views for illustrating the step of joining a mounting pad to a solder ball.

First, as illustrated in FIG. 4A, prepared is a wiring board including a mounting pad 114 exposed on the bottom of an opening between solder mask films 112 formed on a board (not shown).

Then, by a heating step to be performed in manufacturing an electronic device, such as epoxy die adhesive cure, reflow, or post mold cure, an inactive layer 120 formed of a compound contained in the solder mask films 112 or the like is formed on the surface of the mounting pad 114 (FIG. 4B).

Then, a flux 122 is applied, a solder ball 124 is loaded, and then a reflow step is performed (FIGS. 5A and 5B).

However, as illustrated in FIG. 5B, in the reflow step, the inactive layer 120 may not be reduced with the flux in some cases. Therefore, after the reflow step, the solder ball 124 and the mounting pad 114 are not sufficiently joined, resulting in lowering of yields of the product in some cases.

### SUMMARY OF THE INVENTION

According to the present invention, there is provided a flux for soldering, in connecting a mounting pad formed on a board to a solder ball, being applied onto at least one of a surface of the mounting pad and the solder ball, in which: the flux for soldering includes a solvent; and the solvent includes a compound being represented by a general formula (1) and having a boiling point of 218° C. or higher and 240° C. or lower:

R¹-R²n-OH (1),

where: R¹ represents a linear or branched organic group having carbon atoms of 1 or more and 6 or less which may have a substituent, or a phenyl group or a heterocyclic group which may have a substituent; R² represents OCH₂CH₂; and n represents an integer of 1 or more and 5 or less.

Further, according to the present invention, there is provided a method for manufacturing an electronic device which connects a mounting pad exposed on a board to a solder ball, including: applying a flux for soldering onto a surface of the mounting pad; placing the solder ball onto the surface of the mounting pad; and joining the solder ball to the surface of the mounting pad by heating and melting the solder ball, in which: the flux for soldering includes a solvent; and the solvent includes a compound being represented by a general formula (1) and having a boiling point of 218° C. or higher and 240° C. or lower:

R¹-R²n-OH (1),

where: R¹ represents a linear or branched organic group having carbon atoms of 1 or more and 6 or less which may have a substituent, or a phenyl group or a heterocyclic group which may have a substituent; R² represents OCH₂CH₂; and n represents an integer of 1 or more and 5 or less.

Still further, according to the present invention, there is provided a method for manufacturing an electronic device which connects a mounting pad exposed on a board to a solder ball, including: applying a flux for soldering onto the solder ball; placing the solder ball onto a surface of the mounting pad; and joining the solder ball to the surface of the mounting pad by heating and melting the solder ball, in which: the flux for soldering includes a solvent; and the solvent includes a compound being represented by a general formula (1) and having a boiling point of 218° C. or higher and 240° C. or lower:

R¹-R²n-OH (1),

where: R¹ represents a linear or branched organic group having carbon atoms of 1 or more and 6 or less which may have a substituent, or a phenyl group or a heterocyclic group which may have a substituent; R² represents OCH₂CH₂; and n represents an integer of 1 or more and 5 or less.

The flux for soldering of the present invention contains a solvent containing a compound being represented by the general formula (1) and having a boiling point of 218° C. or higher and 240° C. or lower. Therefore, the inactive layer formed of a siloxane compound or the like formed on the surface of the mounting pad may be reduced in the reflow step. Thus, after the reflow step, the solder ball and the mounting pad are sufficiently joined, whereby the product yield may be improved.

According to the present invention, there are provided the flux for soldering capable of reducing the inactive layer formed on the surface of the mounting pad, and the method for manufacturing an electronic device using the same.

### BRIEF DESCRIPTION OF THE DRAWINGS

In the accompanying drawings:

FIGS. 1A and 1B are enlarged cross-sectional views each schematically illustrating a method for manufacturing an electronic device according to embodiments;

FIGS. 2A and 2B are enlarged cross-sectional views each schematically illustrating the method for manufacturing an electronic device according to embodiments;

FIG. 3 is a graph illustrating results of Examples;

FIGS. 4A and 4B are enlarged cross-sectional views each schematically illustrating a method for manufacturing an electronic device for illustrating the problems to be solved by the present invention;

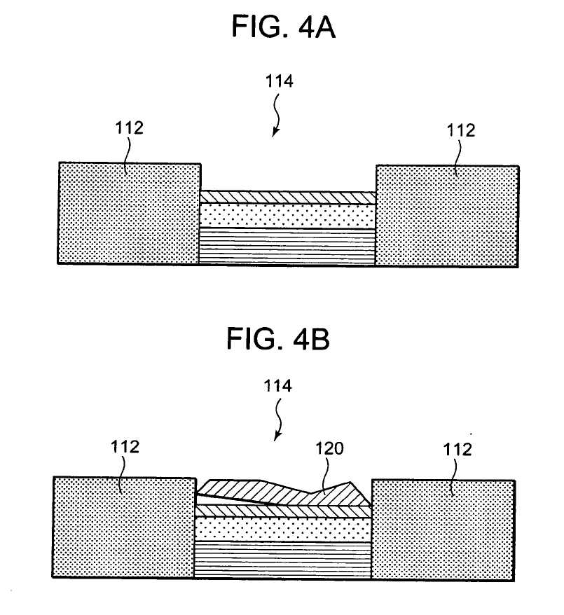

FIGS. 5A and 5B are enlarged cross-sectional views each schematically illustrating the method for manufacturing an electronic device for illustrating the problems to be solved by the present invention; and

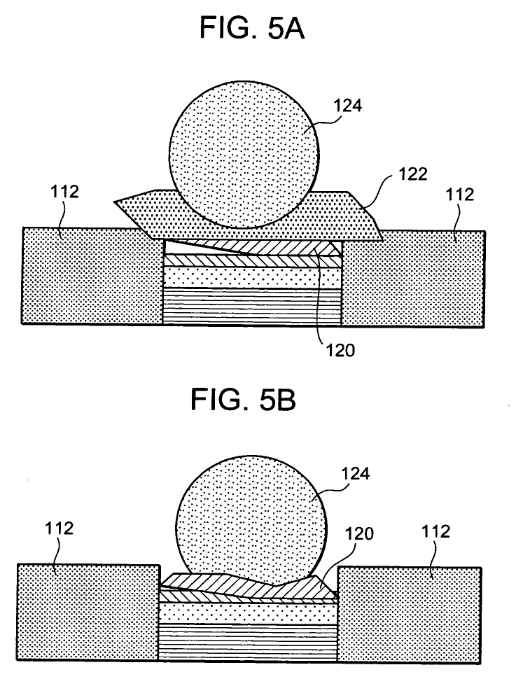

FIG. 6 is a cross-sectional view each schematically illustrating the method for manufacturing an electronic device according to embodiments.

### DETAILED DESCRIPTION OF THE PREFERRED EMBODIMENTS

Hereinafter, embodiments of a flux for soldering of the present invention are described.

The flux for soldering of the present embodiment contains a solvent containing the compound represented by the general formula (1):

R¹-R²n-OH (1),

where: R¹ represents a linear or branched organic group having carbon atoms of 1 or more and 6 or less which may have a substituent, or a phenyl group or a heterocyclic group which may have a substituent; R² represents OCH₂CH₂; and n represents an integer of 1 or more and 5 or less.

In the present embodiment, examples of the linear or branched organic group represented by R¹ include alkyl groups, alkenyl groups, and alkynyl groups.

Examples of the organic group and the substituents of the phenyl group and heterocyclic group include alkyl groups, aryl groups, alkoxy groups, aryloxy groups, alkyloxy groups, an acyl group, an acyloxy group, a hydroxyl group, a thiol group, a carboxyl group, an alkoxycarbonyl group, a keto group, an amino group, and halogens.

In the present embodiment: R¹ in the general formula (1) may represent an alkyl group having carbon atoms of 1 or more and 6 or less, an alkenyl group having carbon atoms of 1 or more and 6 or less, an alkynyl group having carbon atoms of 1 or more and 6 or less, or a phenyl group, which is linear or branched; and n attached to R² may represent an integer of 1 or more and 3 or less.

In the present embodiment, as the compound represented by the general formula (1), there may be used a compound having a boiling point of 218° C. or higher and 240° C. or lower and preferably 218° C. or higher and 238° C. or lower.

As such a compound, one or more kinds selected from the group consisting of ethylene glycol monophenyl ether and diethylene glycol monobutyl ether may be used in combination.

The flux for soldering in the present embodiment may contain the compound represented by the general formula (1) in 10 wt % or more and 75 wt % or less and preferably 20 wt % or more and 65 wt % or less with respect to the total weight of the flux for soldering.

Note that, the solvent used of the present embodiment may contain another solvent other than the compound represented by the general formula (1) as long as the effects of the present invention are not impaired. Examples of the another solvent include diisopropyl ether and diethyl ether. The content of the another solvent is 5 wt % or less with respect to the total weight of the flux for soldering.

The flux for soldering of the present embodiment may further contain an organic acid, an amine compound, and a nonionic surfactant. Each compound is described in sequence.

Examples of the organic acid include tartaric acid, adipic acid, dimethylolpropionic acid, and oxydiacetate. The flux for soldering of the present embodiment may contain the organic acid in an amount of 1 wt % or more and 30 wt % or less with respect to the total weight of the flux for soldering.

Examples of the amine compound include aromatic alkanol amines. The flux for soldering of the present embodiment may contain the amine compound in an amount of 5 wt % or more and 50 wt % or less with respect to the total weight of the flux for soldering.

An example of the nonionic surfactant includes polyoxyethylene rosin ester. The flux for soldering of the present embodiment may contain the nonionic surfactant in an amount of 1 wt % or more and 50 wt % or less with respect to the total weight of the flux for soldering.

Further, the flux for soldering of the present embodiment may contain other components such as a thickener, a solid formulation, and a dye.

The flux for soldering of the present embodiment may be obtained by dissolving the above-mentioned components into a solvent by a conventional stirring or mixing means.

Next, the embodiment of the method for manufacturing an electronic device of the present invention is described by way of the accompanying drawings. It should be noted that the same constituent is imparted with the same numeral in all the drawings, and the description is omitted as appropriate.

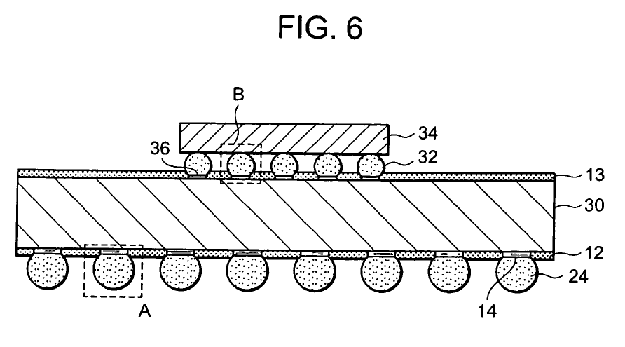

Regarding the method for manufacturing an electronic device of the present embodiment, there is given an example of the method for manufacturing an electronic device illustrated in FIG. 6. In the electronic device shown in FIG. 6, an electronic component 34 is flip-chip mounted on a wiring board 30 through a solder ball 32. The electronic component 34 in the present embodiment is a semiconductor chip, for example. The solder ball 32 is connected to a mounting pad 36 provided on the bottom of an opening of solder mask 13 on the wiring board 30.

In the wiring board 30, a solder ball 24 is provided on the side opposite to the side on which the electronic component 34 is provided. The solder ball 24 is connected to a mounting pad 14 provided on the bottom of an opening of a solder mask 12 on the wiring board 30.

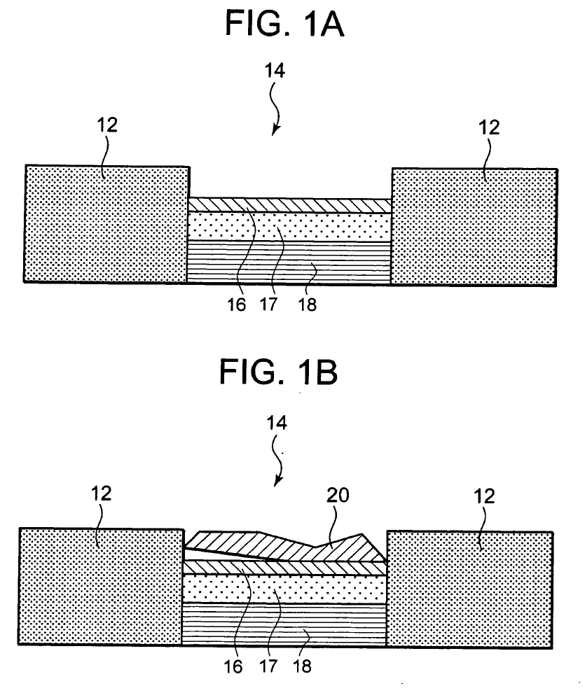

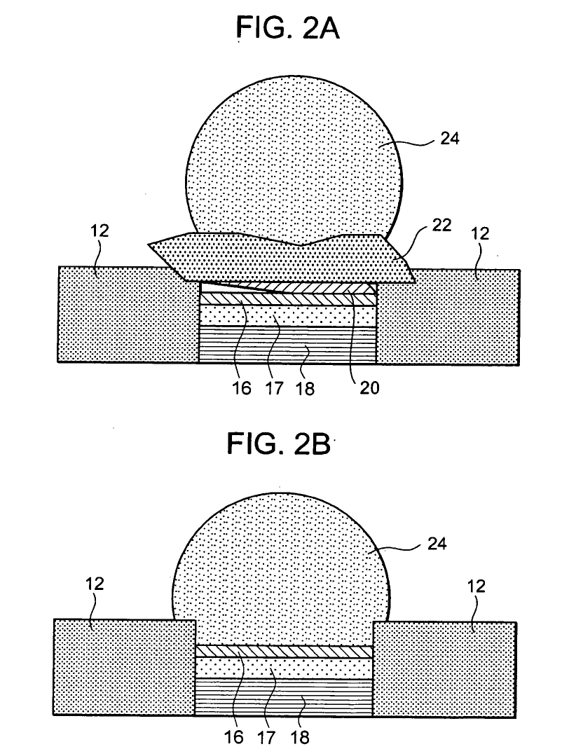

FIGS. 1A and 1B and FIGS. 2A and 2B illustrate the method for manufacturing an electronic device of the present embodiment. FIGS. 1A and 1B and FIGS. 2A and 2B are each an enlarged view of the region surrounded by a dotted line A in FIG. 6. As shown in FIG. 1A, a mounting pad 14 is a stacked structure of Cu electrode 18, Ni plating layer 17, and Au plating layer 16.

At first, the wiring board 30 on which the electric component 34 is mounted through flip-chip bonding is prepared. After that, following steps are performed. The method for manufacturing an electronic device of the present embodiment includes:

(a) heating solder mask films 12 (FIGS. 1A and 1B);

(b) applying a flux for soldering 22 of the present embodiment onto the surface of a mounting pad 14 exposed on the bottom of an opening of the solder mask films 12 formed on a board (not shown) or a solder ball 24;

(c) placing the solder ball 24 onto the surface of the mounting pad 14 (FIG. 2A); and

(d) joining the solder ball 24 to the surface of the mounting pad 14 by heating and melting the solder ball 24 (FIG. 2B).

Hereinafter, explanation is given in accordance with each step.

The step (a): solder mask films 12 are heated (FIGS. 1A and 1B).

First, as illustrated in FIG. 1A, there is prepared an electronic device including the mounting pad 14 exposed on the bottom of an opening of the solder mask films 12 formed on a board (not shown).

Then, by a heating step to be performed in manufacturing an electronic device, such as mount-baking, reflow, and sealing resin-baking, the solder mask films 12 are heated. That is, it is not an object of the present step to heat the solder mask films 12.

The siloxane compound or the like contained in the solder mask films 12 is eluted by the heating step, and an inactive layer 20 is formed on the surface of the mounting pad 14 (FIG. 1B)

The step (b): a flux for soldering 22 of the present embodiment is applied onto the surface of the mounting pad 14 exposed on the bottom of the opening of the solder mask films 12 formed on a board (not shown).

The application method and the application amount of the flux for soldering 22 are not particularly limited, and may be performed in accordance with a conventional method.

The solder mask films 12 may contain a siloxane compound. Examples of the siloxane compound include a polydimethylsiloxane derivative and a degradation product thereof. Examples of the polydimethylsiloxane derivative include polydimethylsiloxane, a condensation polymer of polydimethylsiloxane such as dimethicone, and polydimethylsiloxane in which a methyl group is replaced by another functional group.

It should be noted that the flux for soldering 22 may be applied onto the solder ball 24 instead of the surface of the mounting pad 14.

The step (c): the solder ball 24 is placed onto the surface of the mounting pad 14 (FIG. 2A).

As a method for placing the solder ball 24 onto the surface of the mounting pad 14, a conventional method may be used. The solder ball 24 may include an Sn solder, an Sn—Ag solder, an Sn—Cu solder, or an Sn—Ag—Cu solder.

The step (d): the solder ball 24 is heated and melted to join the solder ball 24 to the surface of the mounting pad 14 (FIG. 2B).

The heating and melting (reflow) of the solder ball 24 may be performed at temperature of 230° C. or higher and 260° C. or lower. The present step may reduce the inactive layer 20 from the surface of the mounting pad 14.

Also in the joining step, the siloxane compound may be eluted from the solder mask films 12. However, the flux for soldering of the present embodiment may be also used to effectively reduce the eluted siloxane compound.

Then, the electronic device is produced in accordance with a conventional method.

Hereinafter, effects of the present embodiment are described.

The flux for soldering of the present embodiment contains a solvent containing the compound represented by the above general formula (1).

When the inactive layer formed of a substance eluted from the solder mask films by heating the solder mask films is formed on the surface of the mounting pad 14, the flux for soldering of the present embodiment may reduce the inactive layer 20 in the reflow step. Thus, after the reflow step, the solder ball and the mounting pad are sufficiently joined, whereby the product yield may be improved.

Further, in the present embodiment, the boiling point of the compound represented by the general formula (1) may be set to be 218° C. or higher and 240° C. or lower and preferably 238° C. or lower. In addition, a solder reflow temperature may be set to be 230° C. or higher and 260° C. or lower.

Since the compound has a boiling point within the above-mentioned range, the inactive layer 20 may be effectively reduced in the reflow step on the basis of the relationship of the boiling point and the reflow temperature. Thus, after the reflow step, the solder ball and the mounting pad are sufficiently joined, whereby the product yield may be further improved.

It should be noted that, when the compound represented by the general formula (1) has a boiling point of lower than 218° C., a solvent component may be volatilized and inactivated prior to achievement of the melting temperature of the solder, whereby an effect of reducing the inactive layer 20 tends to decrease. On the other hand, when the compound represented by the general formula (1) has a boiling point of higher than 240° C., the melting of the solder occurs prior to achievement of the temperature region in which the solvent exerts its activity, and hence an effect of reducing the inactive layer 20 becomes insufficient.

In the present embodiment, the solder mask films may contain a siloxane compound. Examples of the siloxane compound include polydimethylsiloxane and a degradation product thereof, a condensation polymer of polydimethylsiloxane such as dimethicone, and polydimethylsiloxane in which a methyl group is replaced by another functional group.

Conventionally, a flux for soldering is added with a solvent: However, after the reflow step, the solder ball and the mounting pad are not sufficiently joined in some cases.

The siloxane compound contained in the solder mask films, in particular, polydimethylsiloxane is eluted onto the surface of the mounting pad when the solder mask films are heated, and simultaneously the inactive layer is formed on the surface of the mounting pad. So the inventors of the present invention have intensively studied, and found a novel problem that the inactive layer may not be reduced with a conventional flux, and the presence of the inactive layer makes the joining between the solder ball and the mounting pad insufficient, resulting in decrease in the product yield.

The inventors of the present invention have further intensively studied, and found that the compound being represented by the general formula (1) and having the above-mentioned boiling point may dissolve the siloxane compound to effectively reduce the inactive layer. Thus, the present invention has been accomplished.

Further, in the present embodiment, as the compound represented by the general formula (1), a water-soluble compound may be used.

After the step of solder joining, a flux residue may be washed with water used in the step of cutting a board or the like, and hence a washing step may not be provided separately, whereby the simplified manufacturing step may be accomplished.

### EXAMPLE

Hereinafter, the present invention is further described in detail by way of Examples, but the present invention is not limited thereto.

It should be noted that, a rate of an incompletely joined solder ball is evaluated as follows.

A flux is applied onto a Ni/Au land of a printed board on which a solder mask is applied, and a solder ball is loaded thereon. After that, solder is immediately heated and melted by using a reflow device, to thereby melt the land and the solder. After the reflow, the ball surface is subjected to weight bearing, whereby the land is exposed at the ball joint which is unjoined. The rate of the incompletely joined solder ball was calculated by dividing the unjoined ball number by the total ball number.

### Example 1

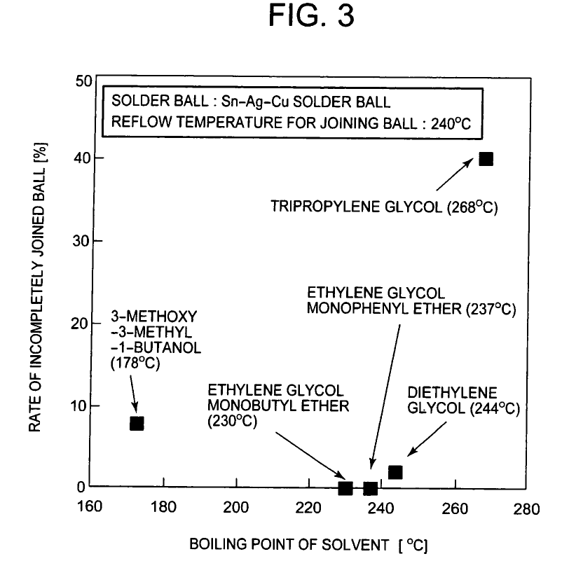

In accordance with the manufacturing method as described in FIGS. 1 to 2, the electronic device was manufactured under the following condition. FIG. 3 illustrates the evaluation results of the rate of the incompletely joined solder ball.

### (Electronic Device)

Solder ball: Sn—Ag—Cu solder ball

Solder mask films: acrylic resin 36.4%, polydimethylsiloxane (PDMS) 1.4%, filler (BaSO₄, SiO₂, talc) 37.3%, photosensitive agent 2.5%, acrylic resin 4.7%, epoxy resin 16.0%, and others (remainder)

Reflow temperature: 240° C.

### (Flux)

Solvent: ethylene glycol monobutyl ether (boiling point of 230° C.), 25 wt %

Organic acid: adipic acid 5 wt %

Amine compound: polyamine resin 30 wt %

Nonionic surfactant: polyoxyethylene rosin ester 40 wt %

The above components are mixed, whereby a flux was produced.

### Example 2

An electronic device was produced in the same manner as in Example 1 except that ethylene glycol monophenyl ether (boiling point of 237° C.) was used as a solvent. FIG. 3 shows the results.

### Comparative Examples 1 to 3

Electronic devices were produced in the same manner as in Example 1 except that 3-methoxy-3-methyl-1-butanol (boiling point of 178° C.), diethylene glycol (boiling point of 244° C.), and tripropylene glycol (boiling point of 268° C.) were each used as a solvent, and the electronic devices were used for Comparative Examples 1 to 3, respectively. FIG. 3 shows the results.

As described in FIG. 3, according to the flux using ethyleneglycol monobutyl ether (boiling point of 230° C.) or ethylene glycol monophenyl ether (boiling point of 237° C.), the rate of the incompletely joined solder ball was 0%. In contrast, according to the flux using 3-methoxy-3-methyl-1-butanol (boiling point of 178° C.), diethylene glycol (boiling point of 244° C.), or tripropylene glycol (boiling point of 268° C.), the rate of the incompletely joined solder ball was in a problematic level.

From the foregoing, it was confirmed that the flux for soldering of the present invention was used to remove the inactive layer formed on the Ni/Au land of the printed board, and thus the rate of the incompletely joined solder ball was reduced, whereby the product yield was improved.

The flux for soldering and the method for manufacturing an electronic device according to the present invention are not limited to the above-mentioned embodiments, and a variety of variations may be made. For example, in the above embodiment, there was given an example in which the solder ball was formed on the side opposite to the side on which the electronic component 34 was mounted. However, the structure of the present invention is effective even in the reflow connection of the solder ball 32 connected to the side on which the electronic component 34 is mounted, in the wiring board 30. That is, the embodiment corresponds to the case where the manufacturing method in FIGS. 1A and 1B and FIGS. 2A and 2B are applied with respect to the region surrounded by a dotted line B in FIG. 6. It is needless to say that, also in this case, the same effect is exerted as that in the above embodiment.

What is claimed is:

1. A flux for soldering, in connecting a mounting pad exposed on a board to a solder ball, being applied onto at least one of a surface of the mounting pad and the solder ball, wherein:
the flux for soldering comprises a solvent; and
the solvent comprises a compound being represented by a general formula (1) and having a boiling point of 218° C. or higher and 240° C. or lower:
R¹-R²n-OH (1),
where: R¹ represents a linear or branched organic group having carbon atoms of 1 or more and 6 or less which may have a substituent, or a phenyl group or a heterocyclic group which may have a substituent; R² represents OCH₂CH₂; and n represents an integer of 1 or more and 5 or less.

2. The flux for soldering according to claim 1, wherein R¹ in the general formula (1) represents an alkyl group having carbon atoms of 1 or more and 6 or less, an alkenyl group having carbon atoms of 1 or more and 6 or less, an alkynyl group having carbon atoms of 1 or more and 6 or less, or a phenyl group, which is linear or branched.

3. The flux for soldering according to claim 1, wherein the compound represented by the general formula (1) comprises one of ethylene glycol monophenyl ether and diethylene glycol monobutyl ether.

4. The flux for soldering according to claim 1, wherein the compound represented by the general formula (1) dissolves a siloxane compound.

5. The flux for soldering according to claim 4, wherein the siloxane compound comprises a polydimethylsiloxane derivative and a degradation product thereof.

6. The flux for soldering according to claim 1, wherein the compound represented by the general formula (1) is soluble in water.

7. The flux for soldering according to claim 1, further comprising an organic acid, an amine compound, and a nonionic surfactant.

8. The flux for soldering according to claim 1, wherein the solder ball comprises one of an Sn solder, an Sn—Ag solder, an Sn—Cu solder, and an Sn—Ag—Cu solder.

9. A method for manufacturing an electronic device which connects a mounting pad exposed on a board to a solder ball, comprising:
applying a flux for soldering onto a surface of the mounting pad;
placing the solder ball onto the surface of the mounting pad; and
joining the solder ball to the surface of the mounting pad by heating and melting the solder ball, wherein:
the flux for soldering comprises a solvent; and
the solvent comprises a compound being represented by a general formula (1) and having a boiling point of 218° C. or higher and 240° C. or lower:
R¹-R²n-OH (1),
where: R¹ represents a linear or branched organic group having carbon atoms of 1 or more and 6 or less which may have a substituent, or a phenyl group or a heterocyclic group which may have a substituent; R² represents OCH₂CH₂; and n represents an integer of 1 or more and 5 or less.

10. The method for manufacturing an electronic device according to claim 9, wherein, in joining the solder ball, the solder ball is heated and melted at a solder reflow temperature of 230° C. or higher and 260° C. or lower.

11. The method for manufacturing an electronic device according to claim 9, wherein:
the mounting pad is exposed on a bottom on an opening of solder mask films formed on the board; and
the method further comprises heating the solder mask films prior to applying the flux for soldering.

12. The method for manufacturing an electronic device according to claim 11, wherein the solder mask films comprise a siloxane compound.

13. The method for manufacturing an electronic device according to claim 12, wherein the siloxane compound comprises a polydimethylsiloxane derivative and a degradation product thereof.

14. The method for manufacturing an electronic device according to claim 9, wherein the solder ball comprises one of an Sn solder ball, an Sn—Ag solder ball, an Sn—Cu solder ball, and an Sn—Ag—Cu solder ball.

15. The method for manufacturing an electronic device according to claim 9, wherein, in joining the solder ball to the surface of the mounting pad, the compound represented by the general formula (1) dissolves the siloxane compound adhered on the surface of the mounting pad.

16. A method for manufacturing an electronic device which connects a mounting pad exposed on a board to a solder ball, comprising:
applying a flux for soldering onto the solder ball;
placing the solder ball onto a surface of the mounting pad; and
joining the solder ball to the surface of the mounting pad by heating and melting the solder ball, wherein:
the flux for soldering comprises a solvent; and
the solvent comprises a compound being represented by a general formula (1) and having a boiling point of 218° C. or higher and 240° C. or lower:
R¹-R²n-OH (1),
where: R¹ represents a linear or branched organic group having carbon atoms of 1 or more and 6 or less which may have a substituent, or a phenyl group or a heterocyclic group which may have a substituent; R² represents OCH₂CH₂; and n represents an integer of 1 or more and 5 or less.
